(19) United States
(12) Patent Application Publication
(10) Pub. No.: US 2021/0267239 A1
(43) Pub. Date: Sep. 2, 2021

(54) Process for Sanitizing and Preserving Foodstuffs and Beverages

(71) Applicant: LANXESS Deutschland GmbH, Cologne (DE)

(72) Inventors: Marcus Taupp, Monheim (DE); Ingo Broda (deceased), (US)

(73) Assignee: LANXESS Deutschland GmbH, Cologne (DE)

(21) Appl. No.: 17/253,704

(22) PCT Filed: Jul. 8, 2019
(86) PCT No.: PCT/EP2019/068205

§ 371 Date: Dec. 18, 2020

(30) Foreign Application Priority Data
Jul. 11, 2018 (EP) 18182926.8

(51) Int. Cl. A23L 2/44; A23L 3/3526; A23L 3/3562

(52) U.S. Cl. CPC A23L 2/44; A23L 3/3562; A23L 3/3526

(57) ABSTRACT

The invention relates to a mixture of natamycin and mycosamine and to the use of these mixtures for the degermation and subsequent preservation of foods and drinks, and also to a method for incorporating the mixtures according to the invention into the foods and drinks.

The invention relates to a mixture of natamycin and mycosamine and to the use of these mixtures for the sanitizing and preservation of foods and drinks, and also to a method for incorporating the mixtures according to the invention into the foods and drinks.

Owing to numerous nutrients and various ways of introducing microbes during production, drinks and foods can be easily contaminated by microorganisms, and this ultimately leads to product spoilage and unusability. Furthermore, microbial contamination of drinks and foods represents a health risk to the consumer. Survival or growth of microorganisms in foods and drinks is prevented by using chemical preservatives.

Owing to a globally increasing movement of goods, what are becoming increasingly noticeable in drinks, for example, are microbes which were hitherto unknown to drinks manufacturers. It has become increasingly apparent that preservatives do not have sufficient strength and that very high concentrations are thus used in order to prevent microorganisms from being able to propagate and from thus accordingly contaminating the drink. The use of high concentrations of preservatives, however, is undesirable from an economic point of view and is limited by statutory regulations.

Natamycin, as preservative, is used for treating the surface of cheese and sausages and, in some countries, it is also used for preserving yoghurt, refreshment drinks and also wine and cider.

U.S. Pat. No. 6,136,356 discloses the use of a combination of dimethyl dicarbonate, natamycin and selected sorbates for protecting drinks and foods against mould formation. This mixture too does not act efficiently against all microorganisms.

The active ingredient natamycin has a complex structure and belongs to the group of the so-called polyene macrolides. Also present in the molecule is the so-called mycosamine, an amino sugar. Natamycin, as active substance, exhibits a limited stability under environmental conditions and may decompose into various products under the influence of pH, temperature, oxidation and light. In an acid, such as, for example, in wine or soft drinks, natamycin decomposes rapidly by hydrolysis. In this case, the amino sugar mycosamine is released (Brik H., 1976, The Journal of Antibiotics, VOL. XXIX NO. 6, pages 632-637).

Therefore, there continues to be a need for an effective degermation and preservation mixture which makes it possible to overcome the disadvantages from the prior art.

It has now been found that, surprisingly, mycosamine has, in combination with natamycin, a synergistic and improved effect against microorganisms.

The invention therefore provides a mixture containing natamycin and mycosamine in an amount >95% by weight, based on the total weight of the mixture.

Natamycin (CAS No. 7681-93-8, also called pimaricin) is (8E,14E,16E,18E,20E)-(1R,3S,5R,7R,12R,22R,24S,25R,26S)-22-(3-amino-3,6-dideoxy-25-D-mannopyranosyloxy)-1,3,26-trihydroxy-12-methyl-10-oxo-6,11,28-trioxatricyclo[22.3.1.05,7]octacosa-8,14,16,18,20-pentaene-25-carboxylic acid.

Mycosamine (CAS No. 527-38-8) is 3-amino-3,6-dideoxymannose.

Natamycin and mycosamine are preferably present in the mixture in an amount >98% by weight, based on the total weight of the mixture. Particularly preferably, the mixture consists of natamycin and mycosamine.

Natamycin and mycosamine are preferably present in the mixture a weight ratio of from 10:1 to 1:10, particularly preferably from 1:8 to 1:3 and very particularly preferably from 1:6 to 1:3.

The mixture according to the invention may be diluted by further additives, such as solvents, or else by other additives, such as, for example, emulsifiers or other suitable food additives. It is then possible to add this diluted mixture to the drink or food. Hydrophilic, organic and water-miscible solvents may be used as solvent. The mixture according to the invention may also be added without further additives to the drinks or foods. Preferably, no additional additive is added.

The mixtures according to the invention may also contain water, salts and/or solvents as contaminants. These constituents are preferably present in the mixture according to the invention in an amount <5% by weight, particularly preferably in an amount <2% by weight. Particularly preferably, the mixture according to the invention does not contain any contaminants.

Moreover, the invention encompasses the use of the mixtures according to the invention for the sanitizing and preservation of foods and drinks.

Preferably, the mixture according to the invention is used in an amount of from 0.01 ppm (mg/l) to 2000 ppm (mg/l), particularly preferably in an amount of from 0.01 ppm (mg/l) to 100 ppm (mg/l), based on the amount of the foods or drinks.

Foods in the context of the invention are preferably dairy products, such as, for example, cheese, yoghurt, ice cream or butter, or margarine, salad dressings, purée, mayonnaise, sauces or sausages or baked goods.

Drinks are preferably understood to mean refreshment drinks and also alcoholic drinks, such as, preferably, soft drinks, fruit juices and fruit juice-containing drinks, flavoured refreshment drinks, such as lemonades, tea (so-called ready-to-drink tea drinks), such as, preferably, iced tea, and sports drinks, mixed drinks of a tea/fruit juice-containing refreshment drink, but also corresponding concentrates, and also wine coolers and dealcoholized wines, wines, cocktails, alcopops, cider and mixed beer drinks. Particularly preferably, drinks are iced teas, sports drinks, fruit juices and fruit juice-containing drinks, wines, cocktails, alcopops, cider and mixed beer drinks.

Preferred microorganisms, against which it is possible to use mixtures according to the invention for sanitizing and preservation, are yeasts and mould. Particularly preferably, the mixtures according to the invention act against Aspergillus chevalieri, Aspergillus clavatus, Aspergillus flavus, Aspergillus nidulans, Aspergillus niger, Aspergillus ochraceus, Aspergillus orycae, Botrytis cinerea, Fusarium sporotrichioides, Gloeosporium album, Mucor mucedo, Penicillium chrysogenum, Penicillium digitatum, Penicillium expansum, Penicillium islandicum, Penicillium notatum, Penicillium roqueforti, Rhizopus oryzae, Candida glabrata, Candida krusei, Saccharomyces cerevisiae, Zygosaccharomyces bailii, Penicillium carneum, Trichoderma virens and Candida albicans. Very particularly preferably, the mixtures according to the invention act against Candida albicans.

Natamycin and mycosamine are commercially available. Natamycin is, for example, available under the name Natamax® from DuPont Danisco Deutschland GmbH. Mycosamine is, for example, commercially available from the USA from BOC Science Ltd.

The sanitizing of the foods or drinks is preferably followed by preservation by means of the active ingredients of the mixture according to the invention.

The invention likewise encompasses a method for sanitizing and preserving foods and drinks, in which the mixture according to the invention is incorporated into the foods or the drinks.

Preferably, the method according to the invention serves for the sanitizing and preservation of drinks. Therefore, the invention preferably encompasses a method for sanitizing and preserving drinks, in which the mixture according to the invention is incorporated into the drinks.

The incorporation of the mixture according to the invention into the drinks preferably proceeds at 4° C. to 40° C., particularly preferably at 8° C. to 30° C.

The drinks into which the mixture is incorporated preferably have a pH of from 5 to 8, particularly preferably a pH of from 6.5 to 7.5.

The incorporation of the mixture according to the invention into the drinks is preferably carried out by means of automatic metering systems. In this case, solution is added directly into the drink stream. Owing to the current, mixing also takes place in the pipe system. Solids can likewise be added. If the mixture according to the invention is used as solids, dissolution is preferably carried out in a separate tank. The mixture according to the invention is then pumped into the drink stream or injected into the drink vessel from the separate tank.

The mixture according to the invention acts in a particularly efficient manner against microorganisms, especially against yeasts and mould. It has been found that, surprisingly, the antimicrobial effect is particularly high in the claimed ranges and that the mixture acts synergistically. As a result, the foods and drinks can be sanitized and preserved in a particularly efficient and cost-effective manner.

### EXAMPLES

### Example 1

A growth medium (RPMI-1640 was prepared according to CLSI standard M27-A3 (CLSI=Clinical and Laboratory Standards Institute)) was contaminated with 1000 CFU/ml (CFU=colony forming units) of microorganisms, and a mixture of natamycin and mycosamine was tested for efficacy in comparison with the individual substances. After one week, a proportion of the growth medium was tested for the presence of microorganisms and these tests were used to determine the MIC (minimum inhibitory concentration).

Individual test substances: natamycin, mycosamine

Test microbe: Candida albicans

Substrate: growth medium

Microbial seeding per ml of substrate: 1000 cfu/ml

TABLE 1

| Individual active | |
|---|---|
| ingredient | MIC (mg/l) after one week |
| Natamycin | 1 mg/l |
| Mycosamine | 32 mg/l |

| Active ingredient | | |
|---|---|---|
| mixture | MIC (mg/l) after one week | Synergistic index |
| Natamycin | 2.5 mg/l | SI = 0.56 |
| Mycosamine | | |
| (weight ratio | | |
| 1:4) | | |

### Example 2

A growth medium (RPMI-1640 was prepared according to CLSI standard M27-A3 (CLSI=Clinical and Laboratory Standards Institute)) was contaminated with 1000 CFU/ml of microorganisms, and a mixture of natamycin and mycosamine was tested for efficacy in comparison with the individual substances. After one week, a proportion of the medium was tested for the presence of microorganisms and these tests were used to determine the MIC (minimum inhibitory concentration).

Individual test substances: natamycin, mycosamine

Test microbe: Candida glabrata

Substrate: growth medium

Microbial seeding per ml of substrate: 1000 cfu/ml

TABLE 2

| Individual active | |
|---|---|
| ingredient | MIC (mg/l) after one week |
| Natamycin | 1 mg/l |
| Mycosamine | 0.5 mg/l |

| Active ingredient | | |
|---|---|---|
| mixture | MIC (mg/l) after one week | Synergistic index |
| Natamycin | 0.625 mg/l | SI = 0.75 |
| Mycosamine | | |
| (weight ratio | | |
| 4:1) | | |

### Example 3

A growth medium (RPMI-1640 was prepared according to CLSI standard M27-A3 (CLSI=Clinical and Laboratory Standards Institute)) was contaminated with a 1000 CFU/ml of microorganisms, and a mixture of natamycin and mycosamine was tested for efficacy in comparison with the individual substances. After one week, a proportion of the medium was tested for the presence of microorganisms and these tests were used to determine the MIC (minimum inhibitory concentration).

Individual test substances: natamycin, mycosamine

Test microbe: Candida krusei

Substrate: growth medium

Microbial seeding per ml of substrate: 1000 cfu/ml

TABLE 3

| Individual active | |
|---|---|
| ingredient | MIC (mg/l) after one week |
| Natamycin | 2 mg/l |
| Mycosamine | 2 mg/l |

| Active ingredient | | |
|---|---|---|
| mixture | MIC (mg/l) after one week | Synergistic index |
| Natamycin | 1.5 mg/l | SI = 0.75 |
| Mycosamine | | |
| (weight ratio | | |
| 2:1) | | |

### Example 4

A drink (iced tea, non-carbonated) was contaminated with 250 CFU/ml each of the microorganisms used and mentioned below, and a mixture of natamycin and mycosamine was tested for efficacy in comparison with the individual substances. After one week, a proportion of the medium was tested for the presence of microorganisms and these tests were used to determine the MIC (minimum inhibitory concentration).

Individual test substances: natamycin, mycosamine

Test microbe: mixture of Saccharomyces cerevisiae, Zygosaccharomyces bailii, Penicillium carneum and Trichoderma virens

Substrate: iced tea, non-carbonated

Microbial seeding per ml of substrate: 250 cfu/ml each of the test microbes listed above

TABLE 4

| Individual active | |
|---|---|
| ingredient | MIC (mg/l) after one week |
| Natamycin | 4 mg/l |
| Mycosamine | 0.75 mg/l |

| Active ingredient | | |
|---|---|---|
| mixture | MIC (mg/l) after one week | Synergistic index |
| Natamycin | 2.25 mg/l | SI = 0.83 |
| Mycosamine | | |
| (weight ratio | | |
| 8:1) | | |

Synergism was ascertained according to the method described in Kull, F. C. et al.; Mixtures of quaternary ammonium compounds and long-chain fatty acids as antifungal agents. Applied Microbiology, 9, 538-541, 1961.

The following relationships apply:

QA/Qa+QB/Qb=SI

Qa=concentration of substance A which is the MIC

Qb=concentration of substance B which is the MIC

QA=concentration of substance A in the concentration of A/B at which microbial growth is suppressed

QB=concentration of substance B in the concentration of A/B at which microbial growth is suppressed

SI=synergistic index

SI=1 means additivity

SI>1 means antagonism

SI<1 means synergism

1-13. (canceled)

14. A mixture comprising:
natamycin and mycosamine in an amount >95% by weight, based on the total weight of the mixture.

15. The mixture according to claim 14, wherein the natamycin and mycosamine are present in the mixture in an amount >98% by weight, based on the total weight of the mixture.

16. The mixture according to claim 14, wherein the natamycin and mycosamine are present in the mixture in a weight ratio of from 1:10 to 10:1.

17. The mixture according to claim 14, wherein the natamycin and mycosamine are present in the mixture in a weight ratio of from 1:8 to 1:3.

18. The mixture according to claim 14, wherein the natamycin and mycosamine are present in the mixture in a weight ratio of from 1:6 to 1:3.

19. A method for degerming drinks or foods, comprising:
incorporating the mixture according to claim 14 into the drinks or foods.

20. The method according to claim 19, wherein the incorporating step is carried out by addition by means of an automatic metering system.

21. The method according to claim 19, wherein the incorporating step is carried out at a temperature of from 4° C. to 40° C.

22. The method according to claim 19, wherein the drinks have a pH of from 5 to 8.

23. The method according to claim 19, wherein the mixture is present in an amount of from 0.01 (mg/l) to 100 (mg/l), based on the amount of drink or food to be treated.

24. The method according to claim 19, wherein the drinks are selected from iced teas, sports drinks, fruit juices, fruit juice-containing drinks, wines, cocktails, alcopops, cider, and mixed beer drinks.

25. The method according to claim 19, wherein the degermation is carried out against the microorganisms Aspergillus chevalieri, Aspergillus clavatus, Aspergillus flavus, Aspergillus nidulans, Aspergillus niger, Aspergillus ochraceus, Aspergillus orycae, Botrytis cinerea, Fusarium sporotrichioides, Gloeosporium album, Mucor mucedo, Penicillium chrysogenum, Penicillium digitatum, Penicillium expansum, Penicillium islandicum, Penicillium notatum, Penicillium roqueforti, Rhizopus oryzae, Candida glabrata, Candida krusei, Saccharomyces cerevisiae, Zygosaccharomyces bailii, Penicillium carneum, Trichoderma virens and Candida albicans.
